(19) United States
(12) Patent Application Publication
(10) Pub. No.: US 2011/0231892 A1
(43) Pub. Date: Sep. 22, 2011

(54) Systems and Methods for Restricting Online Access

(76) Inventor: Tom C. Tovar, San Francisco, CA (US)

(21) Appl. No.: 12/897,352

(22) Filed: Oct. 4, 2010

Related U.S. Application Data
(63) Continuation-in-part of application No. 12/727,001, filed on Mar. 18, 2010.
(60) Provisional application No. 61/370,556, filed on Aug. 4, 2010.

(51) Int. Cl. G06F 21/00; H04L 9/00

(52) U.S. Cl. 726/1; 726/12

(57) ABSTRACT

Systems and methods for restricting online access include a user interface module to establish a user interface between a network user with administrative authority and an Internet service or a DNS server and a communication module to receive, from the network user with administrative authority, restriction parameters associated with a restriction policy for a network. The restriction parameters may include a company name, a website name, and a category name. Based on the parameters, the system may determine one or more Uniform Resource Locators (URLs) to be associated with the restriction policy. The system may further comprise an activation module to activate and deactivate the restriction policy. The system may restrict a URL requested by a network user based on the determination that the restriction policy is activated and the URL is associated with the restriction policy.

### CROSS-REFERENCE TO RELATED APPLICATIONS

This nonprovisional patent application is a continuation-in-part application that claims the priority benefit of U.S. patent application Ser. No. 12/727,001 filed on Mar. 18, 2010, titled “Internet Mediation,” and provisional U.S. Patent Application Ser. No. 61/370,556, filed on Aug. 4, 2010, titled “Internet Mediation Applications,” which are hereby incorporated by reference in their entirety.

### FIELD OF THE INVENTION

This application relates generally to data processing and more specifically to systems and methods for restricting online access and use.

### BACKGROUND

Disciplining children when their behavior fails to adhere to socially accepted norms is an ancient concept. By applying behavioral rules, parents can teach their children to deal with the consequences of their behavior. Parents may set up rules regarding homework, housework, visits by friends, curfews, and Internet use. When a child breaks a rule, taking away privileges is often a plan of action.

The consequences to breaking rules provide an incentive to children to maintain good behavior and performance. It can be safely assumed that a majority of children will be encouraged to maintain good behavior in view of these consequences. Thus, children who fail to complete chores, challenge the authority of their parents, disobey parental directives, or fail to demonstrate good and proper habits (such as cleaning their rooms, completing homework, and helping other family members) face the prospect of losing their privileges.

When determining punishment for breaking a rule, parents often evaluate what would be the most effective means for achieving their goal and balance the punishment against the current infraction. Nowadays, children spend a lot of time on the Internet socializing with friends and hearing about the new gossip, both of which are vital to their social lives. Taking away their access to social lifeline would have a big impact on them and hopefully remedy their bad behavior. Accordingly, parents may want to punish their children by taking away specific Internet privileges if the children's behaviors are not in line with the parents' expectations. However, the Internet is not limited to the social networking, micro-blogging, and video-sharing Internet content so popular with children. The Internet can be used for vital communications between family members and as a reference source for completing homework. Therefore, complete blocking of the Internet access can be unacceptable.

Usage of parental control software that can block Internet access selectively has been on the rise. However, the functionality within the existing parental control software is limited because restrictive settings need to be applied to every web-enabled device that a child can access. Furthermore, the existing software does not automatically generate a list of blocked Internet content and does not have blocking capability for a user-selected period of time. Therefore, parents would have to manually enter the websites into the blacklist and then manually remove them from the blacklist once the restriction period is over.

### SUMMARY OF THE INVENTION

Various embodiments of the present invention disclose methods for restricting online access, the method may include utilizing a user interface between a network user with administrative authority and an Internet service. The network user with administrative authority may establish restriction parameters that define a restriction policy for the Internet service. The restriction parameters may include Internet content and access times. The restriction policy may vary in response to behavior of the network users as indicated by their historic network usage. The method may apply the restriction policy to a user request to access specific Internet content. A policy enforcement module may determine whether or not the restriction policy is in effect to deny access to the Internet content.

A system to selectively restrict online access includes a user interface module to provide a user interface between a network user with administrative authority and an Internet service. The system may also include a communication module to receive restriction parameters from the network user with administrative authority via the user interface. The restriction parameters establish a restriction policy for the Internet service. The restriction parameters may include Internet content names and addresses and access times. The restriction policy may be variable in response to behavior of the network users as indicated by their historic network usage. The system may further include a policy generating module to establish, based on the restriction parameters, the restriction policy for the network. A policy enforcement module may apply the restriction policy to a user request to access a specific URL to determine whether or not the restriction policy is in effect to block access to the requested URL.

### BRIEF DESCRIPTION OF THE DRAWINGS

Exemplary embodiments are illustrated by way of example and not limitation in the figures of the accompanying drawings, in which like references indicate similar elements.

FIG. 1 is a block diagram of a restriction policy module, in accordance with various embodiments of the present technology.

FIG. 2 illustrates a flow chart of a method for restricting online access.

FIG. 3 is a screenshot of a description associated with a restriction policy application.

FIG. 4 is a screenshot of a configuration webpage for an end-user to provide configuration parameters associated with a restriction policy.

FIG. 5 is a screenshot of a terminal webpage that can appear in the event that a Internet content is blocked according to the restriction policy.

FIG. 6 is a block diagram of a Domain Name Server (DNS) server environment.

FIG. 7 is a block diagram of a system within which a restriction policy is implemented.

FIG. 8 is a computing system that may be used to implement the methods for restricting online access.

### DETAILED DESCRIPTION

Systems and methods for restricting online access, in some exemplary embodiments, allow blocking access to specific Internet content and/or categories of Internet content within a specific network in an attempt to improve unwanted behavior exhibited by a network user. For example, a category of social networking Internet content can be restricted when a network user fails to reach scholastic objectives or otherwise deviates from agreed to objectives. The approach is intended to provide a predetermined set of consequences that can be enacted regardless of the character of the unwanted behavior. Because the network user may highly value a specific class of Internet content or a specific Internet content, he is likely to respond favorably to the blocking by altering his behavior. Thus, the prospect of losing access to his favorite Internet content may provide a large incentive to improve his behavior.

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, and other embodiments can be formed by introducing structural and logical changes without departing from the scope of what is claimed. The following detailed description is, therefore, not to be taken in a limiting sense and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

Generally speaking, an administrator may create and enforce restriction polices for one or more end users that utilize computing devices coupled to an Internet service delivered to a location such as a home, residence place of business or campus. The term “administrator” may include not only individuals, such as parents, but also any individual creating restriction policies regarding the Internet service delivered to end users. It will be understood that an administrator may also be an end user, although end users who are not also administrators may not create or apply restriction policies.

It will be further understood that because of the diversity of computing devices that may connect to the Internet service, the restriction policy may be applied to the Internet service rather than requiring the restriction policy to affect each computing device individually, such as a restriction application resident on each computing device. In various exemplary embodiments a restriction policy may also reside as a stand alone application on one or more of the computing devices.

A restriction policy may also include Internet content collaboratively determined by a group of end users invited by the administrator to collaborate on the establishment of the restriction policy used in the mediation policy. The administrator may, before or after the administrator creates the administrator's own mediation policy, invite the administrator's family members, friends, colleagues or any group of combination of groups and individuals to identify Internet content to be used by the administrator in creating the administrator's own mediation policy. These invitees may or may not be users of the Internet service but will be allowed to contribute to the administrator's mediation policy via the user interface of the Internet service. The administrator may choose to moderate the contributions of individuals or groups invited by the administrator to contribute to the administrator's mediation policy. The administrator may also, before or after the administrator creates the administrator's own mediation policy, join an existing group of users of the Internet service and apply the determinations of age appropriate Internet content by a group to the administrator's own mediation policy. Where there is an existing group that the administrator joins for purposes of creating a mediation policy, the administrator may choose to import the contributions of other groups once or subscribe to these groups to reduce the configuration burden of creating a mediation policy. After the administrator creates the administrator's own mediation policy, the administrator may publish the administrator's mediation policy to be used and/or subscribed to by other users of the Internet service. In such case, other users of the Internet service may import the contributions of administrator once or subscribe to the administrator's mediation policy for use in their own mediation policies. It is understood that via this collaboration two or more user-administrators may combine their mediation policies to create one mediation policy that may be used by these and other administrators of the Internet service.

Exemplary user devices for use with the disclosed systems may have a user interface. In various embodiments, such as those deployed on personal mobile devices, the user interface may be, or may execute, an application, such as a mobile application (hereinafter referred to as an “app”). An app may be downloaded and installed on a user's mobile device. Users may define the access scheme via a user device, such as through the user interface. Some embodiments of the present invention do not require software to be downloaded or installed locally to the user device and, correspondently, do not require the user to execute a de-install application to cease use of the system.

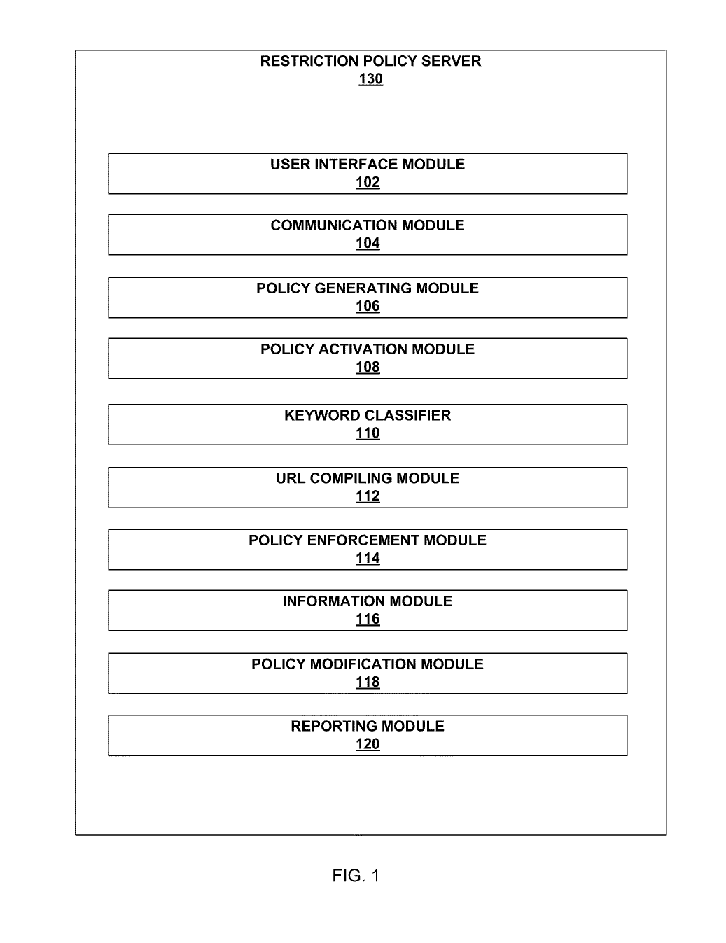

FIG. 1 is a block diagram of a restriction policy system in accordance with various exemplary embodiments of the technology. Alternative embodiments of the restriction policy system may comprise more, less, or functionally equivalent modules. In some example embodiments, the restriction policy system comprises a user interface module 102, a communication module 104, a policy generating module 106, a policy activation module 108, a keyword classifier 110, a URL compiling module 112, a policy enforcement module 114, an information module 116, a policy modification module 118, and a reporting module 120. It will be appreciated by one of ordinary skill that examples of the foregoing modules may be virtual and when instructions are said to be executed by a module may, in fact, be retrieved and executed by a processor. The foregoing modules may also include memory cards, servers, and/or computer discs. Although various modules may be configured to perform some or all of the various steps described herein, fewer or more modules may be provided and still fall within the scope of various embodiments.

The user interface module 102 may be configurable to establish the user interface 710, which may be utilized by a network user 660 with administrative authority at the user device 650. The network user 660 with administrative authority interface 710 generated by the user interface module 102 may include a brief application description and one or more configuration prompts permitting the network user 660 with administrative authority to configure the restriction policy with various parameters. Additionally, the user interface module 102 may enable the network user 660 with administrative authority to activate and deactivate the restriction policy, for example by using an On/Off button.

The communication module 104 may be configurable to provide a communication channel between the restriction policy system and various other components. Additionally, the communication module 104 may enable direct exchange of information between various modules of the restriction policy system. For example, the communication module 104 may facilitate receiving restriction configurations provided by the network user 660 with administrative authority via the user interface 710 and provide a list of restricted URLs in response.

When the network user 660 with administrative authority submits the configurations associated with the restriction policy, the policy generating module 106 may generate an appropriate restriction policy. For example, in response to the network user 660 with administrative authority entering “social networks” as a category of the Internet content he would like to restrict and checking “1 day” check box for the period of time that the restriction should last, the policy generating module 106 may generate a policy which will block social networking Internet content for one day.

In some example embodiments, saving restriction policy configurations may not automatically activate the associated restriction policy. Therefore, the policy activation module 108 may be utilized to activate the restriction policy. The policy activation module 108 may also be utilized to deactivate the restriction policy if the network user 660 with administrative authority decides to terminate the restriction policy earlier or if the duration of the policy is flexible.

In order to specify the restriction policy, the network user 660 with administrative authority may enter a company name, a website name, or a category name. The keyword classifier 110 may be utilized to determine the type of the input received from the network user 660 with administrative authority. Based on this determination, the URL compiling module 112 may populate the intended URL or predetermined category of Internet content that most closely aligns with the request of the network user 660. When the network user 660 tries to access a URL, the policy enforcement module 114 may determine that the restriction policy is active and that the URL is one of the restricted URLs. Upon such determination, the policy enforcement module 114 may enforce the restriction policy by blocking the access to the URL. The policy information module 116 may be utilized to inform a network user 660 that the URL is restricted and why the restriction policy was implemented.

The network user 660 with administrative authority may wish to modify the consequence action throughout the course of the use of the restriction policy based on the observed results. The policy modification module 118 may allow modifying the restriction policy to selectively block an Internet content or a category of Internet content specified by the network user 660 with administrative authority, thereby targeting the Internet content most valuable to encouraging desired behaviors.

The ability to escalate and deescalate the consequence actions may be very important. In general, the network user 660 with administrative authority may not be completely sure whether the initial restriction policy is best suited to elicit the desired changes in the behavior of the network user 660. Instead, the network user 660 with administrative authority may make educated guesses as to what privilege(s) he should take away to produce the desired result. If the initial restriction policy does not result in the desired result, the network user 660 with administrative authority may wish to change or apply additional settings to the restriction policy. This trial and error process may be repeated until the desired results are achieved.

Thus, the network user 660 with administrative authority may alter the Internet content that is prohibited during the course of the restriction policy. To do this, the network user 660 with administrative authority may access the settings and add new Internet content and/or deselect the existing Internet content. The reporting module 120 may be utilized to generate reports associated with the implementation of the restriction policy.

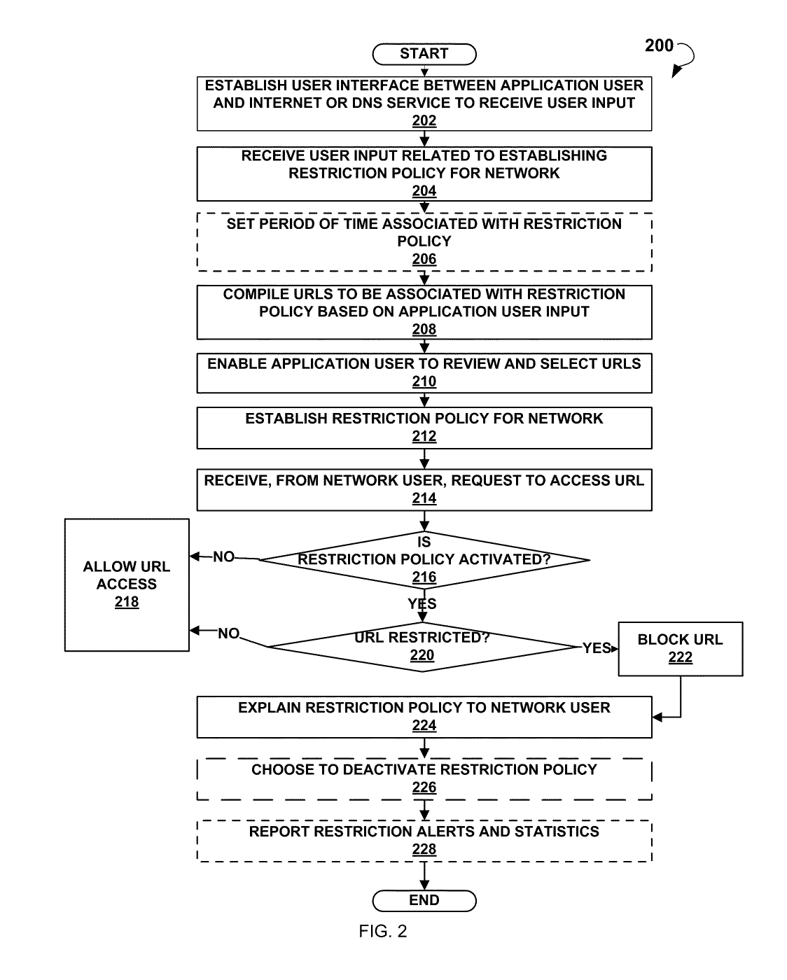

FIG. 2 illustrates a flow chart of a method 200 for restricting online access, in accordance with an example embodiment. The method 200 may be performed by processing logic that may comprise hardware (e.g., dedicated logic, programmable logic, microcode, etc.), software (such as run on a general-purpose computer system or a dedicated machine), or a combination of both. In one example embodiment, the processing logic resides at the restriction policy server 102 as illustrated in FIG. 1.

The method 200 may be performed by the various modules discussed above with reference to FIG. 1. Each of these modules may comprise processing logic. The method 200 may commence at operation 202 with the user interface module 102 establishing the user interface 710 between the network user 660 with administrative authority and the Internet service or the DNS service 670. The network user 660 with administrative authority may have a general idea of what URLs the network user 660 values. Using the user interface 210, the network user 660 with administrative authority may provide input for the baseline restriction policy. As mentioned above, the network user 660 with administrative authority may be able to adjust the restriction policy by adding a new restriction, by modifying the restriction policy, or by deactivating the restriction policy altogether.

Using the user interface 710 the network user 660 with administrative authority may enter configuration requirements for the restriction policy. In some example embodiments, the configuration parameters may include the Internet content and/or Internet content categories that the network user 660 with administrative authority wants restricted for a period of time or until the restriction policy is deactivated. Thus, the network user 660 with administrative authority may input Internet content selections, categories of Internet content selections, a length of the restriction period, and initiate the restriction policy. The method 200 may proceed to optional operation 204, where the communication module 104 of the restriction policy system may receive user input related to the restriction policy.

At operation 206, the network user 660 with administrative authority may set an optional period of time associated with the restriction policy. For example, the network user 660 with administrative authority may select “1 Day” for the restriction period to restrict Internet content and/or categories of Internet content selected for 24 hours. In further examples, if the network user 660 with administrative authority selects “1 Week,” the selected websites/or and categories of websites may not be accessible for 7 days. This means that access to this Internet content should be restored after 168 hours. In yet a further example, the network user 660 with administrative authority may not specify the length of the grounding period at all, thereby selecting an option which will allow implementing the restrictive policy until it is canceled by the network user 660 with administrative authority. With this option, the network user 660 with administrative authority may decide when network user 660 exhibits behavior deserving access to restricted Internet content. As there are no time constraints with this option, the network user 660 with administrative authority may be responsible for removing the restrictions.

In some example embodiments, if the network user 660 with administrative authority would like to schedule the date on which the restrictions are to be removed but does not want to do so manually, he may select an available option which will provide a calendar in which he may select the date he wants the Internet access to go back to normal.

As mentioned above, to create a list of the Internet content to be restricted, the network user 660 with administrative authority may add new Internet content and/or Internet content categories by entering one or more keywords designating an Internet content name or category name in the appropriate field. In some example embodiments, the network user 660 with administrative authority may be able to specify whether the entered keywords designate an Internet content or a category of Internet content (e.g., Bank of America or online games) by selecting an appropriate indication means provided at the user interface. In some example embodiments, the keyword classifier 110 may attempt to determine whether the entered keywords designate an Internet content or a category of Internet content without indication from the network user 660 with administrative authority.

At operation 208, the URL compiling module 112 may generate the URL of the Internet content or a list of the URLs associated with a category name based on what it determines the network user 660 with administrative authority wishes to restrict. The URL compiling module 112 may distinguish categories by labeling them with an appropriate label. In some example embodiments, the network user 660 with administrative authority may be able to review and select URLs at operation 210. There may be other suggestions that the network user 660 with administrative authority may select. The network user 660 with administrative authority may be able to repeat this process until he has entered all of his desired selections. At operation 212, the network user 660 with administrative authority may establish the restriction policy by saving the settings. Internet content may also be created by a network user with administrative authority or socially produced by groups of users with administrative authority.

At operation 214, the communication module 104 may receive, from a network user, a request to access a URL. If there is no active restriction policy at the moment, the policy enforcement module 114 may allow the network user 660 to access the URL at operation 218. If, on the other hand, there is an active restriction policy, the method 200 may proceed to decision block 220 to determine whether or not the URL is restricted. If it is determined at decision block 220 that the URL is not restricted, the policy enforcement module 114 may allow the URL to be accessed at operation 218. If, on the other hand, the URL is restricted, the URL may be blocked at operation 222 and the network user 660 redirected to a default webpage.

Thus, if the network user 660, attempts to access an Internet content that is blocked according to the restriction policy, he may be redirected to the default webpage instead of the requested Internet content. At operation 224, the information module 116, may provide an explanation of why they have been presented with the default webpage and the Internet content he was trying to access. For example, the default webpage may explain that the attempt to access the Internet content by the network user 660 has been denied and that the denial is the result of the restriction policy established by the network user 660 with administrative authority.

At optional operation 226 the network user 660 with administrative authority may choose to terminate the restriction policy by disabling the functionality of the restriction policy application. Upon providing the indication to this end, the policy activation module 108 may deactivate the restriction policy. At optional operation 228, the reporting module 120 may report alerts and statistics associated with the restriction policy. The reports may include, for example, the number of the restrictions, average length of the restrictions, the Internet content restricted under the restriction policy, addresses accessed and attempted to be accessed, number of times visited, duration of visit, whether other links are accessed from the site, etc. The data may be used to “learn” the search patterns of one or more users of the system. The system may then modify the mediation policy according to the learned history of use. The reports may be analyzed to learn patterns and to refine URL and category determinations. This analysis may also help to gauge the effectiveness of the URL compiling module 112 and to determine ways in which it can be improved. Various other notifications associated with the restriction policy may be sent to the network user 660 with administrative authority.

The system may also track various access characteristics to attempt to determine what kind of access was initiated. A beacon or similar tracking tool may be used to determine the amount of time spent by a user on a given site, whether the user clicks on links in the given site, etc. Tracking algorithms may then use the collected data to determine the nature of the site access. For example, the tracking algorithm may indicate whether or not the access of the site was intentional or inadvertent.

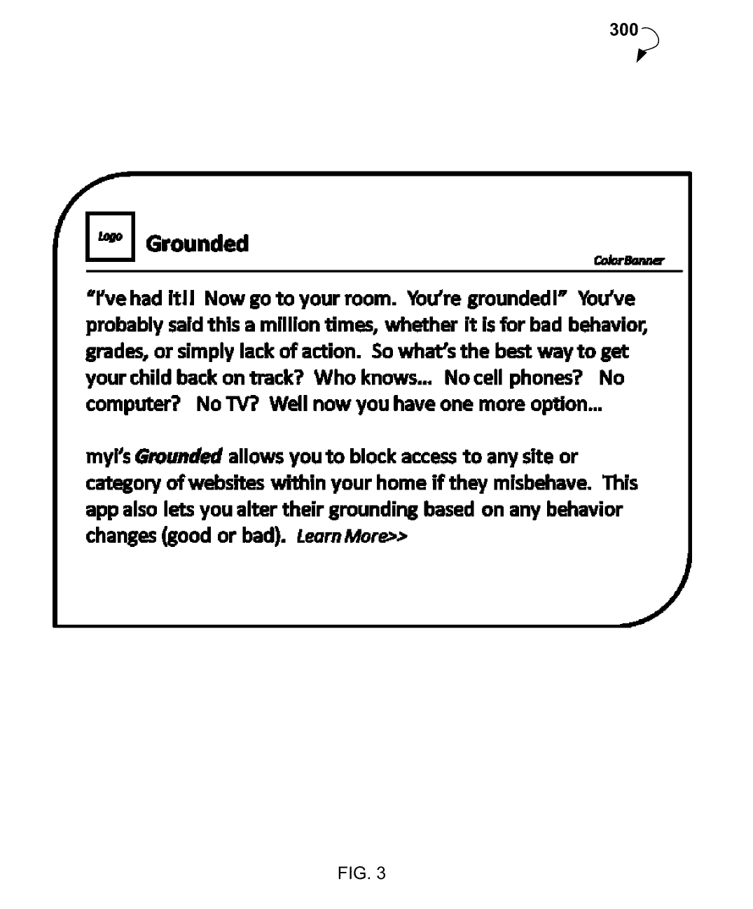

FIG. 3 is a screenshot of a description 300 in accordance with an example embodiment. The description 300 may generally describe what the restriction policy does. As shown in FIG. 3, the description 300 may begin with one or more sentences describing the functionality of the restriction policy. In some example embodiments, the description 300 may outline steps in configuring settings for the restriction policy.

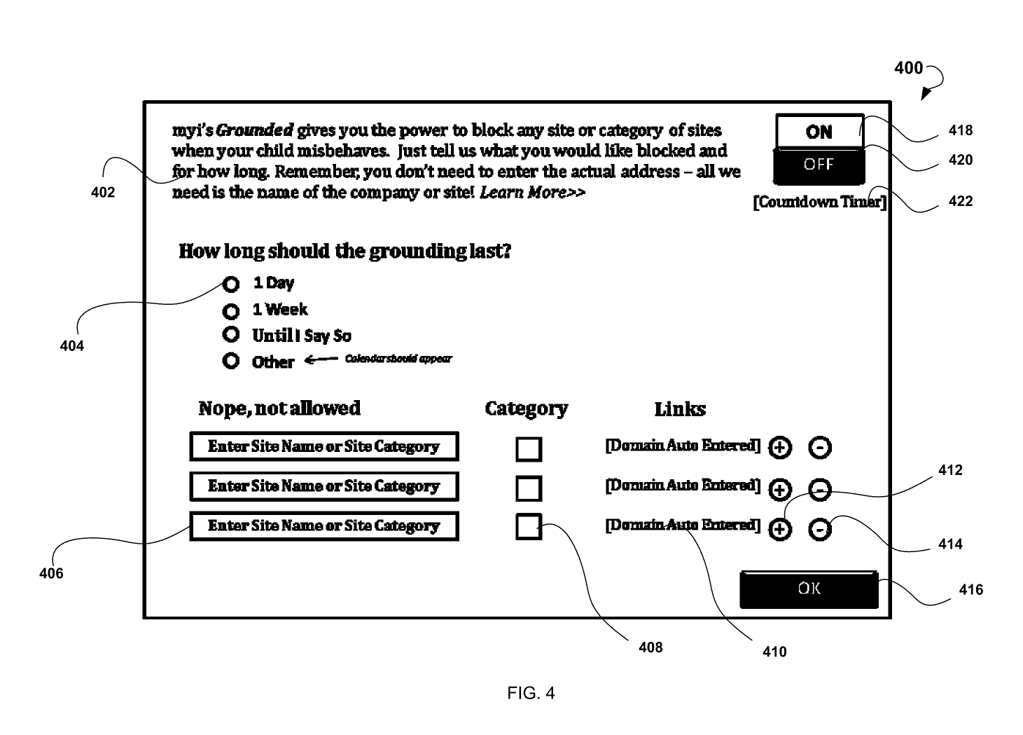

FIG. 4 is a screenshot of a configuration webpage 400. The configuration webpage 400 may be utilized by the network user 660 with administrative authority to provide configuration parameters associated with the restriction policy, in accordance with an example embodiment. In some example embodiments, the configuration webpage 400 may comprise a description text 402, one or more time period radio buttons 404, one or more keyword input fields 406, one or more category check boxes 408, one or more Internet content fields 410, one or more Internet content addition buttons 412, one or more Internet content subtraction buttons 414, a restriction policy save button 416, a restriction policy activation button 418, a restriction policy deactivation button 420, and a countdown timer 422.

In some example embodiments, the network user 660 with administrative authority may provide the length of the restriction policy by selecting the one or more timer period radio buttons 404. For example, if the network user 660 with administrative authority selects “1 Day”, the Internet content and categories selected will be off limits for 24 hours. If the network user 660 with administrative authority selects “1 Week”, the selected Internet content and/or categories will not be accessible for 7 days. If the network user 660 with administrative authority selects “Until I Say So”, he may decide when the network user 660 may access the internet applications 770. There are no time constraints with this option, but the network user 660 with administrative authority will be responsible for removing the restrictions.

If the network user 660 with administrative authority selects “Other”, he can manually schedule the date on which the restriction policy will be terminated. Selecting “Other” may cause the configuration webpage 400 to provide a calendar in which he can select the date he wants the Internet access to go back to normal. Within the configuration webpage 400, the network user 660 with administrative authority may add new Internet content and/or Internet content categories to the restriction policy list by entering an Internet content name or category name in the one or more keyword input fields 408. If the network user 660 with administrative authority has inputted a category name in the one or more keyword input fields 406, he indicate so by clicking on the one or more category check boxes 408.

The one or more Internet content fields 410 may be populated with a URL of the Internet content or the category name based on what is believed the network user 660 with administrative authority wants. If the network user 660 with administrative authority finds the URL to be incorrect, he may click on the one or more Internet content fields 410 to be presented with a drop down menu filled with other suggestions that he may choose from by clicking on the one or more Internet content addition buttons 412 or the one or more Internet content subtraction buttons 414.

The network user 660 with administrative authority may repeat this process until he has entered his selections. At this point the network user 660 with administrative authority may click on the restriction policy saving button 416 to have his settings saved and stored for future use. In some example embodiments clicking on the restriction policy saving button 416 may prompt the configuration webpage 400 to close.

In some example embodiments, if the network user 660 with administrative authority saves the settings but neglects to enable the restriction policy, he may be presented with an overlay asking whether he wishes to enable the restriction policy before closing the configuration webpage 400. If, after the restriction policy is activated, the network user 660 with administrative authority wishes to terminate the restriction policy earlier, he may do so by clicking on the restriction policy deactivation button 420 to disable the restriction policy. Doing so may not result in deleting the settings for the restriction policy. The countdown timer 422 may display the time elapsed since the restriction policy was activated. In addition to the initial setup, the configuration webpage 400 may be used to modify the settings of the restriction policy.

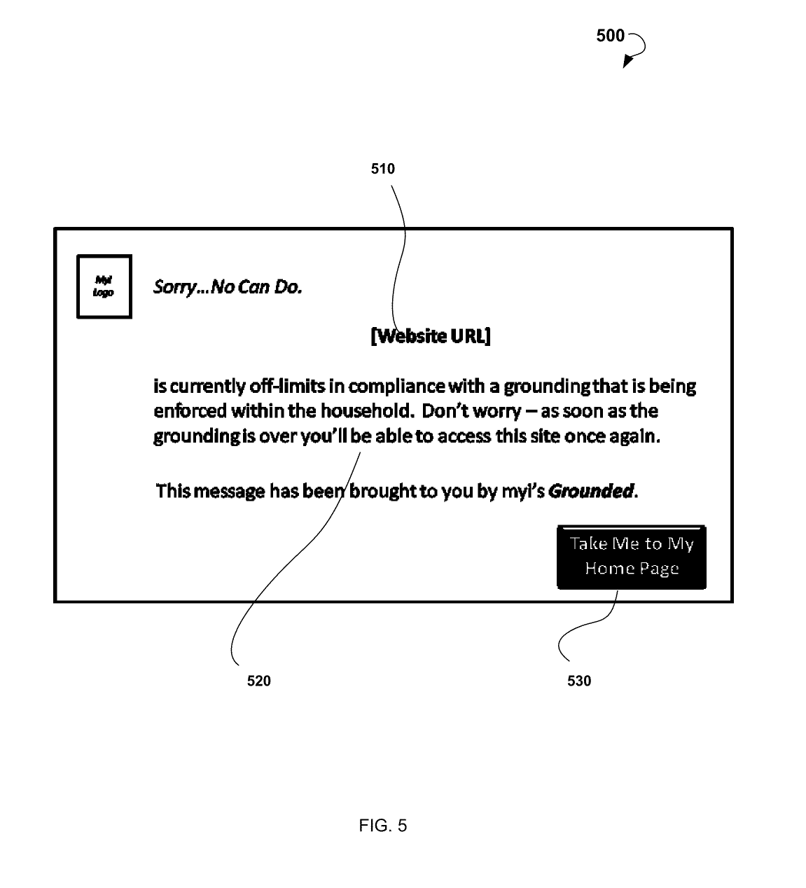

FIG. 5 is a screenshot of a default webpage 500 that may appear in the event that Internet content is blocked according to the restriction policy. In some example embodiments, the default webpage 500 may comprise a blocked URL 510, a message 520, and a home page button 530. If one of the network users 660 attempts to access an Internet content that is blocked by restriction policy, they may be redirected to the default webpage 500 instead of their requested Internet content. The content on the default webpage 500 may include the blocked URL 510 and the message 520 notifying the network users 660 that the network user 660 with administrative authority has requested this action be taken. The message 520 may further inform the network user 660 of the ability to be redirected to their home page (assuming that is not currently the Internet content that is off-limits) by clicking on the home page button 530.

The systems and methods described above may typically be resident in an Internet service or a DNS network. The systems and methods described may also be implemented in plug-in utilities, gateway devices, cable modems, proxy servers, set top boxes, and network interface devices.

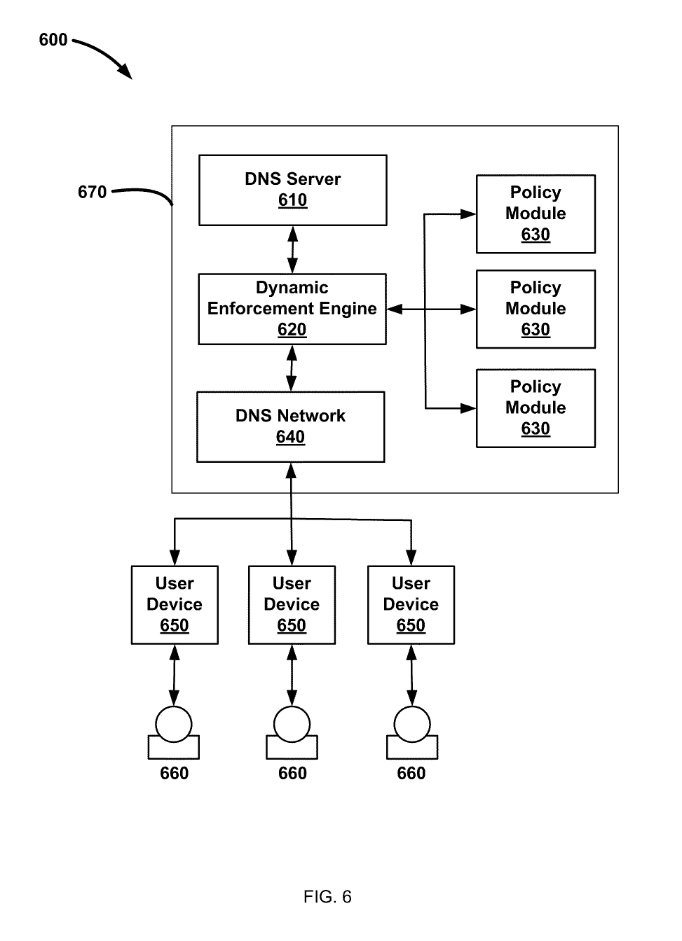

FIG. 6 illustrates an exemplary Internet service system 600, with a DNS server, that may be utilized to support the above described systems and methods. A DNS server 610 operates in conjunction with a dynamic enforcement engine 620. The dynamic enforcement engine 620 may operate in conjunction with one or more policy modules 630 to establish any applicable polices at the DNS 610 level. The content rules are applied to received user queries, and determine the content that is delivered by the DNS network 640 through various user devices 650 to the network users 660.

The dynamic enforcement engine 620 may generate its policy engine on instructions received from one or more policy modules 630. Each policy module 630 may be constructed to provide various types and levels of services to the DNS network 640. In various embodiments, a policy module 630 may be configured to handle queries directed to subjects including, but not limited to, malicious domain redirection, user access redirection, non-existent domain redirection, and data collection or analysis.

It will be recognized by those skilled in the art that the elements of DNS service 670 may be hosted either locally or remotely. In addition to residing in the DNS service 670, one or more of the DNS network 640, the dynamic enforcement engine 620, and the policy modules 630, and any combination thereof, may be resident on one or more user devices 650.

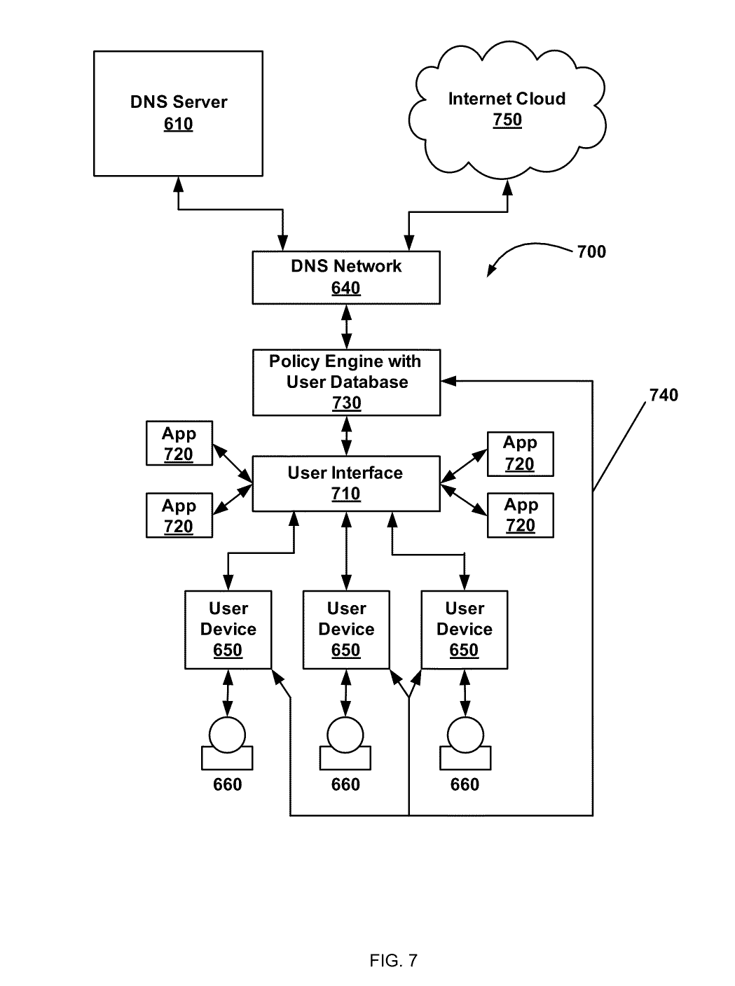

FIG. 7 shows a schematic layout of an exemplary system 700 for implementing direct and variable network user control. FIG. 7 illustrates that the system 700 may operate installed on a DNS server 610, or with a cloud 750 based installation.

The system 700 utilizes a user interface 710. The user interface 710 may be implemented in many embodiments. One specific implementation of the user interface 710 is as a web page.

The user interface 710 may be accessed by one or more user devices 550 operated by the users 560. The user interface 710 may be accessed though a gateway user device 550 available to the users 560. Suitable user devices 550 include but are not limited to desktops, PCs, laptops, notebooks, tablets, gaming devices, IPods, Smartphone, automobile computer systems, and Internet enabled TVs. The system 700 may also be accessed and controlled remotely through user devices 550, such as a Smartphone or other specialized Internet access device. A Smartphone may be defined as a phone with computing capability. A Smartphone may provide the user 560 with Internet access.

The user interface 710 provides a mechanism for one or more authorized users 560 to establish content policy for the Internet service. The user interface 710 operates between the user devices 550 present in the system 700 and the DNS network 540. Instructions resident on the user interface 710 therefore operate on the Internet service, by controlling at least a portion of DNS resolutions via a dynamic policy engine 730, before the service reaches the displays of the user devices 550.

The user interface 710 provides the users 560 with access to one or more policy applications 720. The user interface 710 may provide access to a selection list to at least one authorized user 560. The authorized user 560 uses the selection list or some other menu mechanism to select those policy applications 720 that the user 560 chooses to apply to the system 700. The authorized user 560 may select any number of the available policy applications for use on the system 700 at any given time. In implementations utilizing Smartphones as the user device 550, the policy applications 720 are downloaded to the device 550. The device 550 then serves as the user interface 710 to communicate directly with the dynamic policy engine 730.

The policy applications 720 may prohibit access to specific Internet content. The policy applications 720 may also limit the time of day when users or selected users 560 may access certain Internet content. The policy applications 720 may also manage and analyze duration of access to various Internet content. It is important to note that the policy applications 720 do not simply provide blocking mechanisms by masking or enabling network controls, but rather mediate an Internet service received by the network user. As used herein, mediating the service may include any of blocking, constraining, enabling, redirecting, promoting, demoting, substituting, obscuring, limiting, interrupting, and restricting all or a portion of the Internet service. The policy applications 720 may provide notifications or alerts to one or more users 560 when Internet content is accessed. The policy applications 720 may also provide notification of frequency and duration of access of designated Internet content. The policy applications 720 may also be used to observe, substitute, enable, redirect users, to reward behavior desired from the users by a system administrator, etc. The policy applications 720 may redirect users from a non-favored Internet content to different Internet content. The policy applications 720 may also collect and transmit data characteristic of Internet use.

Access policies supplied by the policy applications 720 may apply to all users 560 of the system 700, or the access policies may be specific to individual users or groups of users 560. The policy applications 720 may be discrete, single purpose applications.

The policy applications 720 provide the users 560 with a mechanism to take various actions relative to their Internet service feed. The policy applications 720 also allow the users 560 to establish a dynamic policy engine 730 that includes a user database. The policy engine 730 is used to enforce rules associated with each policy application associated with individual network users, not simply block various inappropriate Internet content from the Internet feed. Rather, the dynamic policy engine 730, controlled by the user interface 710 through user device(s) 550, is used to manage all aspects of the Internet experience for the users 560. In sum, the policy applications 720 may be used to configure the dynamic policy engine 730 to provide the users 560 with a mechanism to personalize the Internet experience. The policy applications 720 may be configured in combinations, and may each be separately configured.

The database in the policy engine 730 may be used to record and to notify users 560 of various data relative to Internet access. The data collected from and provided to the users 560 may include records of access of specific Internet content, time spent on specific Internet content, time of day of access, data specific to individual users, etc. Users with administrative access can also receive reports denoting the number of implementations, length, or number of URL's blocked.

It should also be noted that following an initial setup through the user interface 710 of the policy engine 730, a direct access 740 enforcement loop may be established between the policy engine 730 and the user devices 550. Subsequent accessing of the DNS network 540 utilizing the direct access 740 decreases response time in the system 700, thereby further enhancing the Internet experience of the users 560. Configurations of policy applications 720 that are selected by one or more users 560 designated as system administrators may remain in the user database of the policy engine 730 until such time as it may be modified by the system administrators. The system administrators may define multiple policy configurations, with a combination of policy applications 720, applicable to one or more network users 560 of the system 700. Each policy application 720 may be separately configurable as well. Policy configurations may vary based upon designated times, conditional triggers, or specific requests from the users 560 with administrative authority.

As indicated above, two discrete data flow paths may be established for the system 700. A first data path establishes a set of enforcement policies for the system 700. The first data path flows from at least one user device 550 through the user interface 710, to the policy enforcement engine 730. A second data path 740 may be utilized following the establishment of a set of policies for the system 700. The second data path 740 flows directly between the user device(s) 550 and the policy engine 730. Multiple sets of enforcement policies may be established and saved within the system 700 and implemented selectively by the users 560.

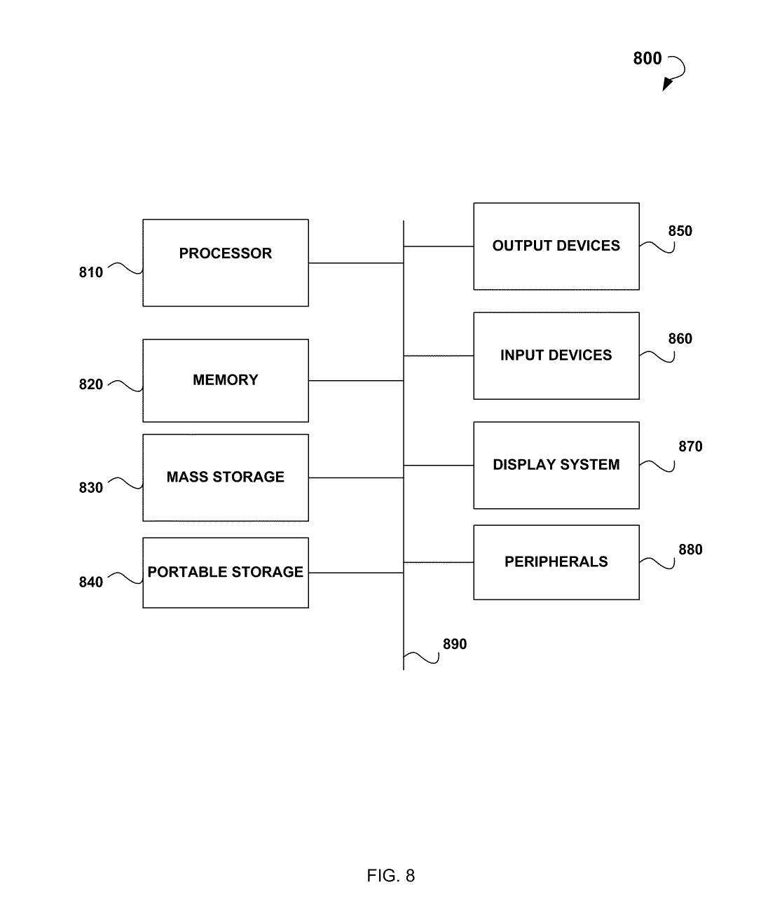

FIG. 8 illustrates an exemplary computing system 800 that may be used to implement an embodiment of the present invention. System 800 of FIG. 8 may be implemented in the context of user devices 650, DNS server 610, Internet cloud 750 and the like. The computing system 800 of FIG. 8 includes one or more processors 810 and memory 820. Main memory 820 stores, in part, instructions and data for execution by processor 810. Main memory 820 can store the executable code when the system 800 is in operation. The system 800 of FIG. 8 may further include a mass storage device 830, portable storage medium drive(s) 840, output devices 850, user input devices 860, a graphics display 840, and other peripheral devices 880.

The components shown in FIG. 8 are depicted as being connected via a single bus 890. The components may be connected through one or more data transport means. Processor unit 810 and main memory 820 may be connected via a local microprocessor bus, and the mass storage device 830, peripheral device(s) 880, portable storage device 840, and display system 870 may be connected via one or more input/output (I/O) buses.

Mass storage device 830, which may be implemented with a magnetic disk drive or an optical disk drive, is a non-volatile storage device for storing data and instructions for use by processor unit 810. Mass storage device 830 can store the system software for implementing embodiments of the present invention for purposes of loading that software into main memory 810.

Portable storage device 840 operates in conjunction with a portable non-volatile storage medium, such as a floppy disk, compact disk or Digital video disc, to input and output data and code to and from the computer system 800 of FIG. 8. The system software for implementing embodiments of the present invention may be stored on such a portable medium and input to the computer system 800 via the portable storage device 840.

Input devices 860 provide a portion of a user interface. Input devices 860 may include an alpha-numeric keypad, such as a keyboard, for inputting alpha-numeric and other information, or a pointing device, such as a mouse, a trackball, stylus, or cursor direction keys. Additionally, the system 800 as shown in FIG. 8 includes output devices 850. Suitable output devices include speakers, printers, network interfaces, and monitors.

Display system 870 may include a liquid crystal display (LCD) or other suitable display device. Display system 870 receives textual and graphical information, and processes the information for output to the display device.

Peripherals 880 may include any type of computer support device to add additional functionality to the computer system. Peripheral device(s) 880 may include a modem or a router.

The components contained in the computer system 800 of FIG. 8 are those typically found in computer systems that may be suitable for use with embodiments of the present invention and are intended to represent a broad category of such computer components that are well known in the art. Thus, the computer system 800 of FIG. 8 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including UNIX, Linux, Windows, Macintosh OS, Palm OS, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the invention. Those skilled in the art are familiar with instructions, processor(s), and storage media.

It is noteworthy that any hardware platform suitable for performing the processing described herein is suitable for use with the invention. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or cartridge, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents. While the present invention has been described in connection with a series of embodiments, these descriptions are not intended to limit the scope of the invention to the particular forms set forth herein. It will be further understood that the methods of the invention are not necessarily limited to the discrete steps or the order of the steps described. To the contrary, the present descriptions are intended to cover such alternatives, modifications, and equivalents as may be included within the spirit and scope of the invention as defined by the appended claims and otherwise appreciated by one of ordinary skill in the art. For example, this description describes the technology in the context of an Internet service in conjunction with a DNS server. It will be appreciated by those skilled in the art that functionalities and method steps that are performed by a DNS server may be performed by an Internet service.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the invention as described herein.

One skilled in the art will further appreciate that the term “Internet content” encompasses any content that may be accessed by the Internet via a user device and may include but not be limited to one or more of web sites, domains, web pages, web addresses, hyperlinks, URLs, any text, pictures, and/or media (such as video, audio, and any combination of audio and video) provided or displayed on a web page, and any combination thereof. Furthermore, a restriction policy for the Internet service may include any of blocking, constraining, enabling, redirecting, promoting, demoting, substituting, obscuring, limiting, and interrupting the service.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or subcombinations. Each of these processes or steps may be implemented in a variety of different ways. Also, while processes or steps are at times shown as being performed in series, these processes or steps may instead be performed in parallel, or may be performed at different times.

From the foregoing, it will be appreciated that specific embodiments of the system have been described herein for purposes of illustration, but that various modifications may be made without deviating from the spirit and scope of the system. Accordingly, the disclosure is not limited except as by the appended claims.

1. A method for selectively restricting online access, the method comprising:
utilizing a user interface between a network user with administrative authority and an Internet service;
receiving from the network user with administrative authority, restriction parameters to establish a restriction policy for the Internet service, wherein the restriction parameters include specific Internet content and access times; and
applying the restriction policy to a user request to access specific Internet content, a policy enforcement module determining whether or not the restriction policy is in effect.

2. The method of claim 1, wherein the user interface provides a mechanism for activating and deactivating the restriction policy.

3. The method of claim 1, wherein at least one element of the restriction policy resides on a DNS server.

4. The method of claim 1, wherein at least one element of the restriction policy is enforced via a DNS server.

5. The method of claim 1, wherein the restriction policy varies in response to behavior of the network users as indicated by their historic network usage.

6. The method of claim 1, wherein the network user with administrative authority establishes different restriction polices for different locations.

7. The method of claim 1, wherein elements of the Internet service reside on user devices.

8. The method of claim 1, wherein the restriction parameters include one or more keywords defining Internet content belonging to one or more of the following: a company name, a website name, and a category name.

9. The method of claim 1, wherein the restriction parameters are contained in a list generated by the Internet service or by third parties.

10. The method of claim 1, wherein the restriction parameters are created by the network user with administrative authority or are produced by groups of network users with administrative authority.

11. The method of claim 1, wherein the restriction policy can be applied to one or more end users of the network.

12. The method of claim 1, wherein the network user with administrative authority shares one or more restriction polices with one or more network users with administrative authority on separate networks.

13. The method of claim 1, wherein the Internet service differentiates between intentional and inadvertent access to Internet content.

14. The method of claim 1, wherein the restriction policy is applied for a predetermined period.

15. The method of claim 1, wherein the restriction policy is removed or modified at any time by the network user with administrative authority.

16. The method of claim 1, further comprising providing to the network user an explanation regarding the restriction policy.

17. The method of claim 1, further comprising:
receiving from the network user with administrative authority, via the user interface, a further request to modify the restriction policy, the request being associated with further restriction parameters; and
based on the further restriction parameters, modifying the restriction policy.

18. The method of claim 1, wherein applying the restriction policy comprises redirecting a request to access Internet content to a notification page.

19. The method of claim 1, wherein applying the restriction policy further comprises displaying a message on the user device.

20. The method of claim 1, wherein a history of all implementations of the restriction policy is reported to the network user with administrative authority.

21. The method of claim 18, wherein the network user with administrative authority modifies the notification page.

22. The method of claim 1, wherein the duration of all implementations of the restriction policy is reported to the network user with administrative authority.

23. The method of claim 1, wherein the restriction policy is collaboratively formed by a plurality of network users.

24. The method of claim 23, wherein at least one of the network users is a user of a network other than that to which the restriction policy is applied.

25. A system for selectively restricting online access, comprising:
a user interface module to provide a user interface between a network user with administrative authority and an Internet service;
a communication module to receive, from the network user with administrative authority restriction parameters to establish a restriction policy for the Internet service, wherein the restriction parameters include Internet content names and addresses and access times;
a policy generating module to establish, based on the restriction parameters, the restriction policy for the network; and
a policy enforcement module to apply the restriction policy to a user request to access a specific Internet content, the policy enforcement module determining whether or not the restriction policy is in effect to block access to the specific Internet content.

26. The system of claim 25, wherein the restriction policy is collaboratively formed by a plurality of network users.

27. The system of claim 26, wherein at least one of the network users is a user of a network other than that to which the restriction policy is applied.

28. The system of claim 25, wherein at least one element of the restriction policy resides on a DNS server.

29. The system of claim 25, wherein at least one element of the restriction policy is enforced via a DNS server.

30. The system of claim 25, wherein the restriction policy varies in response to behavior of the network users as indicated by their historic network usage.

31. The system of claim 25, wherein the Internet service differentiates between intentional and inadvertent access to Internet content.

32. The system of claim 25, further comprising a policy activation module to activate and deactivate the restriction policy.

33. The system of claim 25, wherein the restriction parameters include one or more keywords defining Internet content belonging to one or more of the following: a company name, a website name, and a category name.

34. The system of claim 25, wherein the restriction parameters are contained in a list generated in the Internet Service or by third parties.

35. The system of claim 25, wherein the restriction parameters are created by the network user or are produced by groups of network users.

36. The system of claim 25, wherein the restriction policy can be applied to one or more end users of the network.

37. The system of claim 27, wherein the network user with administrative authority shares one or more restriction polices with one or more network users with administrative authority on separate networks.

38. The system of claim 25, wherein the restriction policy is applied for a predetermined period.

39. The system of claim 25, wherein the restriction policy is removed or modified at any time by the network user with administrative authority.

40. The system of claim 25, further comprising:
receiving from the network user with administrative authority, via the user interface, a further request to modify the restriction policy, the request being associated with further restriction parameters; and
based on the further restriction parameters, modifying the restriction policy.

41. The system of claim 25, wherein blocking access to the Internet content comprises redirecting a request to access Internet content to a notification page.

42. The system of claim 25, wherein blocking the request further comprises displaying a message on the user device.

43. The system of claim 25, wherein a history of all implementations of the restriction policy is reported to the network user with administrative authority.

44. The system of claim 41, wherein the network user with administrative authority modifies the notification page.

45. The system of claim 41, wherein the duration of all implementations of the restriction policy is reported to the network user with administrative authority.

46. The system of claim 41, wherein the URLs of blocked Internet content are reported to the network user with administrative authority.

47. A computer readable storage medium having a program embodied thereon, the program executable by a processor in a computing device to perform a method of mediating Internet service, the method comprising:
utilizing a user interface between a network user with administrative authority and an Internet service;
receiving from the network user with administrative authority via the user interface, restriction parameters to establish a restriction policy for the Internet service, wherein the restriction parameters include site names and addresses and access times, the restriction policy being variable in response to behavior of the network users as indicated by their historic network usage; and
applying the restriction policy to a user request to access a specific URL, a policy enforcement module determining whether or not the restriction policy is in effect to block access to the URL.

48. A method for selectively restricting online access, the method comprising:
utilizing a user interface between a network user with administrative authority and a DNS server;
receiving from the network user with administrative authority via the user interface, restriction parameters to establish a restriction policy for the DNS server, wherein the restriction parameters include Internet content and access times; and
applying the restriction policy to a user request to access specific Internet content, a policy enforcement module of the DNS server determining whether or not the restriction policy is in effect

49. The method of claim 48, wherein the user interface provides a mechanism for activating and deactivating the restriction policy.

50. The method of claim 48, wherein the network user with administrative authority enables different restriction polices for different locations.

51. The method of claim 48, wherein the restriction parameters include one or more keywords defining Internet content belonging to one or more of the following: a company name, a website name, and a category name.

52. The method of claim 51, wherein the restriction parameters are contained in a list generated by the Internet service or by third parties.

53. The method of claim 51, wherein the restriction parameters are created by the network user with administrative authority or are produced by groups of network users with administrative authority.

54. The method of claim 48, wherein the restriction policy can be applied to one or more end users of the network.

55. The method of claim 48, wherein the network user with administrative authority shares one or more restriction polices with one or more network users with administrative authority on separate networks.

56. The method of claim 48, wherein the restriction policy is applied for a predetermined period.

57. The method of claim 48, wherein the restriction policy is removed or modified at any time by the network user with administrative authority.

58. The method of claim 48, further comprising providing to the network user an explanation regarding the restriction policy.

59. The method of claim 48, further comprising:
receiving from the network user with administrative authority, via the user interface, a further request to modify the restriction policy, the request being associated with further restriction parameters; and
based on the further restriction parameters, modifying the restriction policy.

60. The method of claim 48, wherein blocking the Internet content comprises redirecting a request to access Internet content to a notification page.

61. The method of claim 48, wherein blocking the request further comprises displaying a message on the user device.

62. The method of claim 48, wherein a history of all implementations of the restriction policy is reported to the network user with administrative authority.

63. The method of claim 62, wherein the duration of all implementations of the restriction policy is reported to the network user with administrative authority.

64. The method of claim 63, wherein the blocked Internet content is reported to the network user with administrative authority.

65. The method of claim 48, wherein the restriction policy is collaboratively formed by a plurality of network users.

66. The method of claim 65, wherein at last one of the network users is a user of a network other than that to which the restriction policy is applied.

67. The method of claim 48, wherein the restriction policy varies in response to behavior of the network users a indicated by their historic network usage.

68. The method of claim 48, wherein the Internet service differentiates between intentional and inadvertent access to the Internet content.

69. A system for selectively restricting online access, comprising:
a user interface module to provide a user interface between a network user with administrative authority and a DNS server;
a communication module to receive, from the network user with administrative authority via the user interface, restriction parameters wherein the restriction parameters include Internet content names and addresses and access times;
a policy generating module to establish, based on the restriction parameters, a restriction policy for the network; and
a policy enforcement module to apply the restriction policy to a user request to access a specific URL, the policy enforcement module determining whether or not the restriction policy is in effect to block access to the URL.

70. The system of claim 69, further comprising a policy activation module to activate and deactivate the restriction policy.

71. The system of claim 69, wherein the restriction parameters include one or more keywords defining Internet content belonging to one or more of the following: a company name, a website name, and a category name.

72. The system of claim 71, wherein the restriction parameters are contained in a list generated in the DNS server or by third parties.

73. The system of claim 71, wherein the restriction parameters are created by the network user with administrative authority or are produced by groups of network users with administrative authority.

74. The system of claim 69, wherein the restriction policy can be applied to one or more end users of the network.

75. The system of claim 69, wherein the network user with administrative authority shares one or more restriction polices with one or more network users with administrative authority on separate networks.

76. The system of claim 69, wherein the restriction policy is applied for a predetermined period.

77. The system of claim 69, wherein the restriction policy is removed or modified at any time by the network user with administrative authority.

78. The system of claim 69, further comprising providing to the network user an explanation regarding the restriction policy.

79. The system of claim 69, further comprising:
receiving from the network user with administrative authority, via the user interface, a further request to modify the restriction policy, the request being associated with further restriction parameters; and
based on the further restriction parameters, modifying the restriction policy.

80. The system of claim 69, wherein blocking the Internet content comprises redirecting a request to access Internet content to a notification page.

81. The system of claim 69, wherein blocking the request further comprises displaying a message on the user device.

82. The system of claim 69, wherein a history of all implementations of the restriction policy is reported to the network user with administrative authority.

83. The system of claim 82, wherein the duration of all implementations of the restriction policy is reported to the network user with administrative authority.

84. The system of claim 82, wherein the URLs of blocked Internet content are reported to the network user with administrative authority.

85. The system of claim 69, wherein a history of all implementations of the restriction policy is reported to the network user with administrative authority.

86. The system of claim 69, wherein the restriction policy is collaboratively formed by a plurality of network users.

87. The system of claim 86, wherein at last one of the network users is a user of a network other than that to which the restriction policy is applied.

88. The system of claim 69, wherein the restriction policy varies in response to behavior of the network users as indicated by their historic network usage.

89. The system of claim 69 wherein the Internet service differentiates between intentional and inadvertent access to the Internet content.
